(19) United States
(12) Patent Application Publication
(10) Pub. No.: US 2019/0301480 A1
(43) Pub. Date: Oct. 3, 2019

(54) PUMP APPARATUS

(71) Applicant: EBARA CORPORATION, Tokyo (JP)

(72) Inventors: Yoshinori OJIMA, Tokyo (JP); Takahiko OGAWA, Tokyo (JP)

(21) Appl. No.: 16/463,446

(22) PCT Filed: Dec. 4, 2017
(86) PCT No.: PCT/JP2017/043472

§ 371 Date: May 23, 2019

(30) Foreign Application Priority Data
Dec. 26, 2016 (JP) 2016-251085
Dec. 26, 2016 (JP) 2016-251086

(51) Int. Cl. F04D 29/047; F04D 13/06; F04D 15/02; H02K 5/167; H02K 7/08; H02K 7/14; H02K 11/33; H02K 11/35; H02K 21/24; G08B 21/18; G01M 13/045; F16C 17/10

(52) U.S. Cl. CPC F04D 29/0476; F04D 13/0606; F04D 15/0263; H02K 5/1675; H02K 7/085; H02K 7/14; F04D 1/00; H02K 11/35; H02K 21/24; G08B 21/182; G01M 13/045; F16C 17/10; H02K 11/33

(57) ABSTRACT

The present invention relates to a pump apparatus. The pump apparatus includes: an impeller (1) in which a permanent magnet (5) is embedded; a pump casing (2) which houses the impeller (1); a motor stator (6) having a plurality of stator coils (6B); a motor casing (3) which houses the motor stator (6); a bearing assembly (10) which supports the impeller (1); a vibration sensor (30) for detecting a vibration of the bearing assembly (10); and a controller (29) connected to the vibration sensor (30). The controller (29) calculates the rate of change in the vibration based on the vibration detected by the vibration sensor (30) and, when the rate of change in the vibration is higher than a predetermined threshold value, performs at least one of an operation to stop the supply of electric current to the motor stator (6) and an operation to trigger an alarm.

### TECHNICAL FIELD

The present invention relates to a pump apparatus.

### BACKGROUND ART

A canned motor pump, comprising a motor and a pump which are constructed integrally, does not necessitate a shaft sealing device for sealing a gap between a rotating shaft and a pump casing, and therefore is free from leakage of a liquid. Therefore, canned motor pumps are widely used in fields that hate leakage of a liquid. Further, a canned motor pump, equipped with a space-saving axial gap-type PM motor, is preferably used at a location where a reduction in the overall size of an apparatus is desired, such as a site in a semiconductor manufacturing apparatus.

FIG. 18 is a cross-sectional view of a motor pump. The motor pump shown in FIG. 18 is a canned motor pump equipped with an axial gap-type PM motor. As shown in FIG. 18, the motor pump includes an impeller 101 in which a plurality of permanent magnets 105 are embedded, a motor stator 106 which generates a magnetic force acting on the permanent magnets 105, a pump casing 102 which houses the impeller 101, a motor casing 103 which houses the motor stator 106, and a bearing assembly 110 which supports the radial load and the thrust load of the impeller 101. The motor stator 106 and the bearing assembly 110 are disposed on the suction side of the impeller 101.

The impeller 101 is rotatably supported by the single bearing assembly 110. The bearing assembly 110 is a plain bearing (dynamic bearing) that uses a dynamic pressure of a liquid. The bearing assembly 110 is comprised of a combination of a rotation-side bearing 111 and a stationary-side bearing 112 which are in loose engagement with each other. The rotation-side bearing 111 is secured to the impeller 101, while the stationary-side bearing 112 is secured to the motor casing 103.

Part of a liquid, discharged from the impeller 101, is directed to the bearing assembly 110 through a slight gap between the impeller 101 and the motor casing 103. When the rotation-side bearing 111 rotates together with the impeller 101, the dynamic pressure of the liquid is generated between the rotation-side bearing 111 and the stationary-side bearing 112, whereby the impeller 101 is supported by the bearing assembly 110 in a non-contact manner.

### CITATION LIST

### Patent Literature

Patent document 1: Japanese laid-open patent publication No. H11-299195

Patent document 2: Japanese laid-open patent publication No. 2010-174670

### SUMMARY OF INVENTION

### Technical Problem

The liquid which has been directed to the bearing assembly 110 sometimes contains foreign matter which can clog the gap in the bearing assembly 110, i.e. the gap between the rotation-side bearing 111 and the stationary-side bearing 112. If the operation of the motor pump is continued with the gap in the bearing assembly 110 clogged with foreign matter, the bearing assembly 110 could be damaged and, in the worst case, the motor pump could fail.

If the motor pump is operated in the absence of a liquid being transferred, no liquid is introduced into the gap between the rotation-side bearing 111 and the stationary-side bearing 112, and therefore the rotation-side bearing 111 can directly contact the stationary-side bearing 112. When the operation of the motor pump in such a state is continued, the rotation-side bearing 111 will slide on the stationary-side bearing 112, and frictional heat will be generated between the rotation-side bearing 111 and the stationary-side bearing 112. This may cause seizure of the bearing assembly 110, which could result in damage to the bearing assembly 110 and, in the worst case, could result in a failure of the motor pump.

The above problems may arise not only in the motor pump shown in FIG. 18 but also in canned motor pumps having other structures, for example, a canned motor pump including a pump section and a motor section. Such a canned motor pump has a structure which allows internal circulation of a liquid. A canned motor pump may sometimes be referred to herein simply as a motor pump. Part of a liquid, which has been sucked into a pump casing of the pump section, is directed to the motor section and flows through a gap formed between a bearing that rotatably supports a rotating shaft and a rotation-side member secured to the rotating shaft. In this manner, the liquid cools and lubricates the bearing, and is returned from the motor section to the pump section.

If foreign matter is contained in the liquid that has been directed to the motor section, the foreign matter can clog the gap between the bearing and the rotation-side member. When the operation of the motor pump is continued with the gap clogged with foreign matter, the bearing could be damaged and, in the worst case, the motor pump could fail.

If the motor pump is operated in the absence of a liquid being transferred, no liquid is introduced into the gap between the bearing and the rotation-side member, and therefore the bearing can directly contact the rotation-side member. When the operation of the motor pump in such a state is continued, the rotation-side member will slide on the bearing, and frictional heat will be generated between the bearing and the rotation-side member. This may cause seizure of the bearing, which could result in damage to the bearing and, in the worst case, could result in a failure of the motor pump.

The present invention has been made in view of the above problems. It is therefore an object of the present invention to provide a pump apparatus which can prevent damage to a bearing assembly or a bearing even when foreign matter clogs a gap in the bearing assembly or a gap between the bearing and a rotation-side member.

The present invention has been made in view of the above problems. It is therefore an object of the present invention to provide a pump apparatus which can prevent damage to a bearing assembly or a bearing, caused by the operation of a motor pump in the absence of a liquid.

### Solution to Problem

In one embodiment, a pump apparatus comprises: an impeller in which a permanent magnet is embedded; a pump casing which houses the impeller; a motor stator having a plurality of stator coils; a motor casing which houses the motor stator; a bearing assembly which supports the impeller; a vibration sensor for detecting a vibration of the bearing assembly; and a controller connected to the vibration sensor, wherein the controller calculates the rate of change in the vibration based on the vibration detected by the vibration sensor and, when the rate of change in the vibration is higher than a predetermined threshold value, performs at least one of an operation to stop the supply of electric current to the motor stator and an operation to trigger an alarm.

In a preferred embodiment, the pump apparatus further comprises an inverter device which supplies electric current to the motor stator, the threshold value is a first threshold value, and the controller is connected to the inverter device, calculates the rate of change in the electric current supplied from the inverter device to the motor stator and, when the rate of change in the vibration is higher than the first threshold value, and the rate of change in the electric current increases and exceeds a second threshold value, performs at least one of an operation to stop the supply of electric current to the motor stator and an operation to trigger an alarm.

In a preferred embodiment, the bearing assembly comprises a stationary-side bearing, and a rotation-side bearing disposed around the stationary-side bearing, the rotation-side bearing secured to the impeller and the stationary-side bearing secured to the motor casing, and the vibration sensor is embedded in the motor casing.

In a preferred embodiment, the bearing assembly comprises a stationary-side bearing, and a rotation-side bearing disposed around the stationary-side bearing, the rotation-side bearing secured to the impeller and the stationary-side bearing secured to the motor casing, and the vibration sensor is embedded in the stationary-side bearing.

In another embodiment, a pump apparatus comprises: an impeller in which a permanent magnet is embedded; a pump casing which houses the impeller; a motor stator having a plurality of stator coils; a motor casing which houses the motor stator; a bearing assembly which supports the impeller; a sound sensor for detecting a sound generated by the bearing assembly; and a controller connected to the sound sensor, wherein the controller calculates the rate of change in the sound based on the sound detected by the sound sensor and, when the rate of change in the sound is higher than a predetermined threshold value, performs at least one of an operation to stop the supply of electric current to the motor stator and an operation to trigger an alarm.

In a preferred embodiment, the pump apparatus further comprises an inverter device which supplies electric current to the motor stator, the threshold value is a first threshold value, and the controller is connected to the inverter device, calculates the rate of change in the electric current supplied from the inverter device to the motor stator and, when the rate of change in the sound is higher than the first threshold value, and the rate of change in the electric current increases and exceeds a second threshold value, performs at least one of an operation to stop the supply of electric current to the motor stator and an operation to trigger an alarm.

In yet another embodiment, a pump apparatus comprises: an impeller in which a permanent magnet is embedded; a pump casing which houses the impeller; a motor stator having a plurality of stator coils; a motor casing which houses the motor stator; a bearing assembly which supports the impeller; a temperature sensor for detecting a temperature of the bearing assembly; and a controller connected to the temperature sensor, wherein the controller calculates the rate of change in the temperature based on the temperature detected by the temperature sensor and, when the rate of change in the temperature is higher than a predetermined threshold value, performs at least one of an operation to stop the supply of electric current to the motor stator and an operation to trigger an alarm.

In a preferred embodiment, the pump apparatus further comprises an inverter device which supplies electric current to the motor stator, the threshold value is a first threshold value, and the controller is connected to the inverter device, calculates the rate of change in the electric current supplied from the inverter device to the motor stator and, when the rate of change in the temperature is higher than the first threshold value, and the rate of change in the electric current increases and exceeds a second threshold value, performs at least one of an operation to stop the supply of electric current to the motor stator and an operation to trigger an alarm.

In a preferred embodiment, the bearing assembly comprises a stationary-side bearing, and a rotation-side bearing disposed around the stationary-side bearing, the rotation-side bearing secured to the impeller and the stationary-side bearing secured to the motor casing, and the temperature sensor is embedded in the motor casing.

In a preferred embodiment, the bearing assembly comprises a stationary-side bearing, and a rotation-side bearing disposed around the stationary-side bearing, the rotation-side bearing secured to the impeller and the stationary-side bearing secured to the motor casing, and the temperature sensor is embedded in the stationary-side bearing.

In yet another embodiment, a pump apparatus comprises: an impeller; a rotating shaft to which the impeller is secured; a pump casing which houses the impeller; a motor for rotating the rotating shaft; a motor casing which houses the motor; a bearing which supports the rotating shaft; a physical quantity sensor for detecting a physical quantity of the bearing; and a controller connected to the physical quantity sensor, wherein the controller calculates the rate of change in the physical quantity based on the physical quantity detected by the physical quantity sensor and, when the rate of change in the physical quantity is higher than a predetermined threshold value, performs at least one of an operation to stop the supply of electric current to the motor and an operation to trigger an alarm.

In a preferred embodiment, the pump apparatus further comprises a casing cover secured to a high pressure-side opening of the pump casing, the motor casing includes an end cover disposed on the opposite side of the motor from the casing cover, the bearing is comprised of a first bearing mounted to the casing cover, and a second bearing mounted to the end cover, and the physical quantity sensor is comprised of a first physical quantity sensor embedded in the casing cover, and a second physical quantity sensor embedded in the end cover.

In a preferred embodiment, the pump apparatus further comprises a casing cover secured to a high pressure-side opening of the pump casing, the motor casing includes an end cover disposed on the opposite side of the motor from the casing cover, the bearing is comprised of a first bearing mounted to the casing cover, and a second bearing mounted to the end cover, and the physical quantity sensor is comprised of a first physical quantity sensor embedded in the first bearing, and a second physical quantity sensor embedded in the second bearing.

In a preferred embodiment, the pump apparatus further comprises a control unit including the controller and an inverter device which supplies electric current to the motor, and the pump casing, the motor casing and the control unit are disposed linearly in the axial direction of the rotating shaft.

In a preferred embodiment, the physical quantity sensor is selected from a vibration sensor for detecting a vibration of the bearing, a sound sensor for detecting a sound generated by the bearing, and a temperature sensor for detecting a temperature of the bearing.

### Advantageous Effects of Invention

When the rate of change in a vibration of the bearing assembly is higher than a predetermined threshold value, the controller can perform at least one of an operation to stop the supply of electric current to the motor stator and an operation to trigger an alarm. Therefore, the pump apparatus can prevent damage to the bearing assembly even when foreign matter clogs a gap in the bearing assembly.

When the rate of change in a sound generated by the bearing assembly is higher than a predetermined threshold value, the controller can perform at least one of an operation to stop the supply of electric current to the motor stator and an operation to trigger an alarm. Therefore, the pump apparatus can prevent damage to the bearing assembly even when foreign matter clogs a gap in the bearing assembly.

When the rate of change in the temperature of the bearing assembly is higher than a predetermined threshold value, the controller can perform at least one of an operation to stop the supply of electric current to the motor stator and an operation to trigger an alarm. Therefore, the pump apparatus according to the present invention can prevent damage to the bearing assembly caused by operating the motor pump in the absence of a liquid.

When the rate of change in a physical quantity of the bearing is higher than a predetermined threshold value, the controller can perform at least one of an operation to stop the supply of electric current to the motor and an operation to trigger an alarm. Therefore, the pump apparatus can prevent damage to the bearing even when foreign matter clogs a gap between the bearing and a rotation-side member. Furthermore, the pump apparatus can prevent damage to the bearing caused by operating the motor pump in the absence of a liquid.

### BRIEF DESCRIPTION OF DRAWINGS

FIG. 1 is a cross-sectional view showing an embodiment of a pump apparatus;

FIG. 2 is a diagram showing an embodiment of a position where a vibration sensor is disposed;

FIG. 3 is a diagram showing another embodiment of a position where a vibration sensor is disposed;

FIG. 4 is a diagram showing yet another embodiment of a position where a vibration sensor is disposed;

FIG. 5 is a schematic view showing the overall construction of a pump apparatus;

FIG. 6 is a diagram showing another embodiment of a pump apparatus;

FIG. 7 is a diagram showing yet another embodiment of a pump apparatus;

FIG. 8 is a cross-sectional view showing yet another embodiment of a pump apparatus;

FIG. 9 is a diagram showing an embodiment of a position where a temperature sensor is disposed;

FIG. 10 is a diagram showing another embodiment of a position where a temperature sensor is disposed;

FIG. 11 is a diagram showing yet another embodiment of a position where a temperature sensor is disposed;

FIG. 12 is a schematic view showing the overall construction of a pump apparatus;

FIG. 13 is a cross-sectional view showing yet another embodiment of a pump apparatus;

FIG. 14 is a cross-sectional view showing yet another embodiment of a pump apparatus;

FIG. 15 is a cross-sectional view showing yet another embodiment of a pump apparatus;

FIG. 16 is a cross-sectional view showing yet another embodiment of a pump apparatus;

FIG. 17 is a cross-sectional view showing yet another embodiment of a pump apparatus; and

FIG. 18 is a cross-sectional view of a motor pump.

### DESCRIPTION OF EMBODIMENTS

Embodiments of the present invention will now be described with reference to the drawings. In the drawings, the same symbols are used for the same or equivalent components or elements, and a duplicate description thereof is omitted.

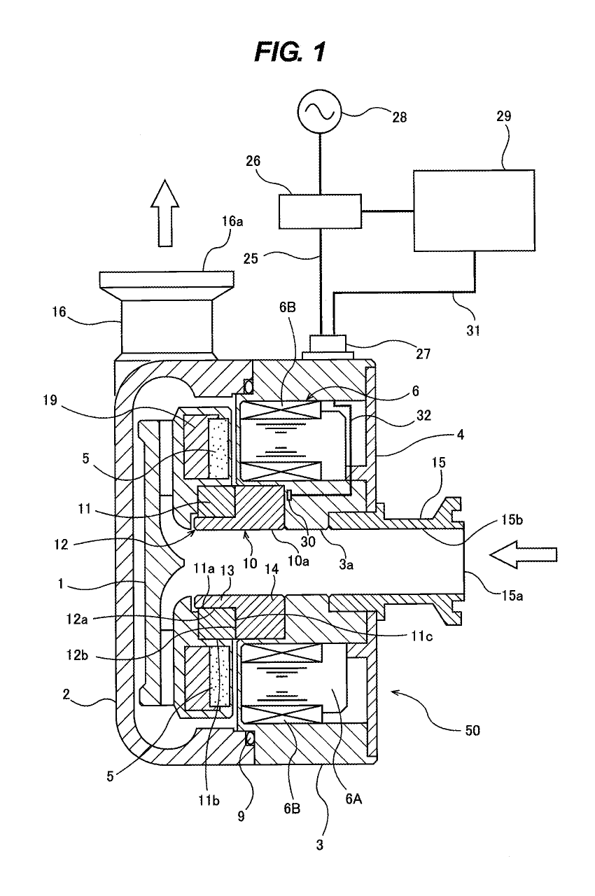

FIG. 1 is a cross-sectional view showing an embodiment of a pump apparatus. The pump apparatus includes a motor pump 50 comprised of a motor and a pump which are constructed integrally. The motor pump 50 shown in FIG. 1 is a canned motor pump equipped with an axial gap-type PM motor. As shown in FIG. 1, the motor pump 50 includes an impeller 1 in which a plurality of permanent magnets 5 are embedded, a motor stator 6 which generates a magnetic force acting on the permanent magnets 5, a pump casing 2 which houses the impeller 1, a motor casing 3 which houses the motor stator 6, an end cover 4 which closes the open end of the motor casing 3, and a bearing assembly 10 which supports the radial load and the thrust load of the impeller 1.

The motor stator 6 and the bearing assembly 10 are disposed on the suction side of the impeller 1. Though the plurality of permanent magnets 5 are provided in this embodiment, the present invention is not limited to this embodiment: a single permanent magnet having a plurality of magnetic poles may be used. In particular, it is possible to use a single annular permanent magnet having a plurality of magnetic poles which have been magnetized into alternating S poles and N poles.

An O-ring 9 as a sealing member is provided between the pump casing 2 and the motor casing 3. The provision of the O-ring 9 can prevent leakage of a liquid from between the pump casing 2 and the motor casing 3.

A suction port 15 having a suction opening 15a is liquid-tightly coupled to the motor casing 3. The suction port 15 has a flange-like shape, and is connected to a not-shown suction line. Liquid flow passages 15b, 3a, 10a are formed in the centers of the suction port 15, the motor casing 3 and the bearing assembly 10, respectively. The liquid flow passages 15b, 3a, 10a are connected in a line and constitute a liquid flow passage extending from the suction opening 15a to the liquid inlet of the impeller 1.

The motor pump 50 of this embodiment is a canned motor pump equipped with an axial gap-type PM motor having the permanent magnets 5 and the motor stator 6, disposed along the liquid flow passages 15b, 3a, 10a.

A discharge port 16 having a discharge opening 16a is provided on a side surface of the pump casing 2. A liquid, whose pressure has been raised by the rotating impeller 1, is discharged through the discharge opening 16a. The motor pump 50 of this embodiment is a so-called end-top motor pump in which the suction opening 15a and the discharge opening 16a are mutually orthogonal.

The impeller 1 is formed of a smooth and wear-resistant non-magnetic material. For example, a resin such as PTFE (polytetrafluoroethylene) or PPS (polyphenylene sulfide), or a ceramic is preferably used. The pump casing 2 and the motor casing 3 (including the end cover 4) may be formed of the same material as that of the impeller 1.

The impeller 1 is rotatably supported by the single bearing assembly 10. The bearing assembly 10 is a plain bearing (dynamic bearing) that uses the dynamic pressure of a fluid. The bearing assembly 10 is comprised of a combination of a rotation-side bearing 11 and a stationary-side bearing 12 which are in loose engagement with each other. The rotation-side bearing 11 is secured to the impeller 1 and disposed such that it surrounds the fluid inlet of the impeller 1. The stationary-side bearing 12 is secured to the motor casing 3 and disposed on the suction side of the rotation-side bearing 11. The stationary-side bearing 12 includes a cylindrical portion 13, and a flange portion 14 extending outward from the cylindrical portion 13. The cylindrical portion 13 extends in the axial direction of the rotation-side bearing 11. The cylindrical portion 13 and the flange portion 14 are constructed integrally.

The cylindrical portion 13 has a radial surface (outer peripheral surface) 12a that supports the radial load of the impeller 1, while the flange portion 14 has a thrust surface (side surface) 12b that supports the thrust load of the impeller 1. The radial surface 12a is parallel to the axis of the impeller 1, while the thrust surface 12b is perpendicular to the axis of the impeller 1. The rotation-side bearing 11 is disposed around the cylindrical portion 13 of the stationary-side bearing 12.

The rotation-side bearing 11 has an inner surface 11a facing the radial surface 12a of the stationary-side bearing 12, an outer surface 11b opposite the inner surface 11a, and a side surface 11c extending between the inner surface 11a and the outer surface 11b. The side surface 11c of the rotation-side bearing 11 faces the thrust surface 12b of the stationary-side bearing 12. A slight gap is formed between the inner surface 11a of the rotation-side bearing 11 and the radial surface 12a, and between the side surface 11c of the rotation-side bearing 11 and the thrust surface 12b. A not-shown sealing member is provided between the rotation-side bearing 11 and the impeller 1, so that the rotation-side bearing 11 is liquid-tightly secured to the impeller 1. Similarly, a not-shown sealing member is provided between the stationary-side bearing 12 and the motor casing 3, so that the stationary-side bearing 12 is liquid-tightly secured to the motor casing 3.

Part of a fluid, discharged from the impeller 1, is directed to the bearing assembly 10 through a slight gap between the impeller 1 and the motor casing 3. When the rotation-side bearing 11 rotates together with the impeller 1, a dynamic pressure of the fluid is generated between the rotation-side bearing 11 and the stationary-side bearing 12, whereby the impeller 1 is supported by the bearing assembly 10 in a non-contact manner. Since the stationary-side bearing 12 supports the rotation-side bearing 11 with the radial surface 12a and the thrust surface 12b which are mutually orthogonal, tilting of the impeller 1 is restricted by the bearing assembly 10.

The motor stator 6 includes a stator core 6A and a plurality of stator coils 6B. The stator coils 6B are arranged in a ring. The impeller 1 and the motor stator 6 are arranged concentrically with the bearing assembly 10 and the suction opening 15a.

Leads 25 are connected to the stator coils 6B, and a connector 27 is mounted to the exterior surface of the motor casing 3. The stator coils 6B are connected to an inverter device 26 via the leads 25 and the connector 27. The inverter device 26 is connected to a power source 28, and is also connected to a controller 29 which controls the operation of the inverter device 26.

The inverter device 26 supplies electric current to the stator coils 6B of the motor stator 6 to generate a rotating magnetic field in the motor stator 6. The rotating magnetic field acts on the permanent magnets 5 embedded in the impeller 1, and rotationally drives the impeller 1. The torque of the impeller 1 depends on the intensity of the electric current supplied to the motor stator 6. The electric current supplied to the motor stator 6 is approximately constant as long as the load applied to the impeller 1 is constant.

When the impeller 1 rotates, a liquid is directed from the suction opening 15a to the liquid inlet of the impeller 1. The pressure of the liquid is raised by the rotation of the impeller 1, and the liquid is discharged from the discharge opening 16a. While the impeller 1 is transferring the liquid, the back surface of the impeller 1 is pressed toward the suction side (i.e. toward the suction opening 15a) by the liquid whose pressure has been raised. Since the bearing assembly 10 is disposed on the suction side of the impeller 1, the bearing assembly 10 supports the thrust load of the impeller 1 from the suction side.

When foreign matter is contained in the liquid being transferred by the rotation of the impeller 1, the foreign matter can enter the bearing assembly 10. If the foreign matter, which has entered the bearing assembly 10, clogs the gap in the bearing assembly 10 (more specifically the gap between the rotation-side bearing 11 and the stationary-side bearing 12), the gap-clogging foreign matter may impede the rotation of the impeller 1 and cause an abnormal vibration of the bearing assembly 10. Foreign matter contained in the liquid can also clog the gap between the impeller 1 and the motor casing 3. Also in this case, the gap-clogging foreign matter may impede the rotation of the impeller 1 and cause an abnormal vibration of the bearing assembly 10.

If the operation of the motor pump 50 is continued with the gap in the bearing assembly 10 (and/or the gap between the impeller 1 and the motor casing 3) clogged with foreign matter, the bearing assembly 10 could be damaged, and the motor pump 50 could fail. In view of this, as shown in FIG. 1, a vibration sensor (vibration detector) 30 for detecting a vibration of the bearing assembly 10 is disposed in the motor casing 3 adjacent to the bearing assembly 10. The vibration sensor 30 is, for example, a contact-type vibration sensor. An acceleration sensor such as a strain gauge, for example, can be used as the vibration sensor 30.

In this embodiment, the vibration sensor 30 is embedded in the motor casing 3 at a position between the stationary-side bearing 12 and the end cover 4 and nearer to the stationary-side bearing 12. In particular, the vibration sensor 30 is located in the vicinity of the stationary-side bearing 12. The vibration sensor 30, located close to the stationary-side bearing 12, can more securely detect a vibration of the bearing assembly 10.

In order to more securely transmit a vibration of the bearing assembly 10 to the vibration sensor 30, the bearing assembly 10 is preferably made of a material that easily transmits vibration. For example, the bearing assembly 10 is made of a hard material such as a ceramic or a metal.

The single vibration sensor 30 is used in this embodiment. However, the number of vibration sensors 30 is not limited to one: two or more vibration sensors may be used. In the case of using a plurality of vibration sensors 30, the vibration sensors 30 may be disposed at regular intervals in the circumferential direction of the stationary-side bearing 12.

As shown in FIG. 1, the vibration sensor 30 is connected to a signal line 32 which, in turn, is connected a sensor cable 31 via the connector 27. The sensor cable 31 is connected to the controller 29. Thus, the vibration sensor 30 is connected to the controller 29 via the signal line 32 and the sensor cable 31. The vibration sensor 30 may be connected to the controller 29 by a single wire.

In this embodiment, the vibration sensor 30 is disposed in the motor casing 3, and the signal line 32 is connected to the connector 27 through the motor casing 3, the end cover 4 and the space in which the motor stator 6 is disposed. According to this embodiment, the vibration sensor 30 and the signal line 32 are disposed in an area where there is no fear of entry of a liquid being transferred by the operation of the motor pump 50. Therefore, the vibration sensor 30 can be installed relatively easily without the need for special waterproofing.

Further, according to this embodiment, the signal line 32 extends in the space in which the motor stator 6 is disposed, and therefore the leads 25 and the sensor cable 31 can be easily connected to the inverter device 26 and the controller 29, respectively, via the connector 27.

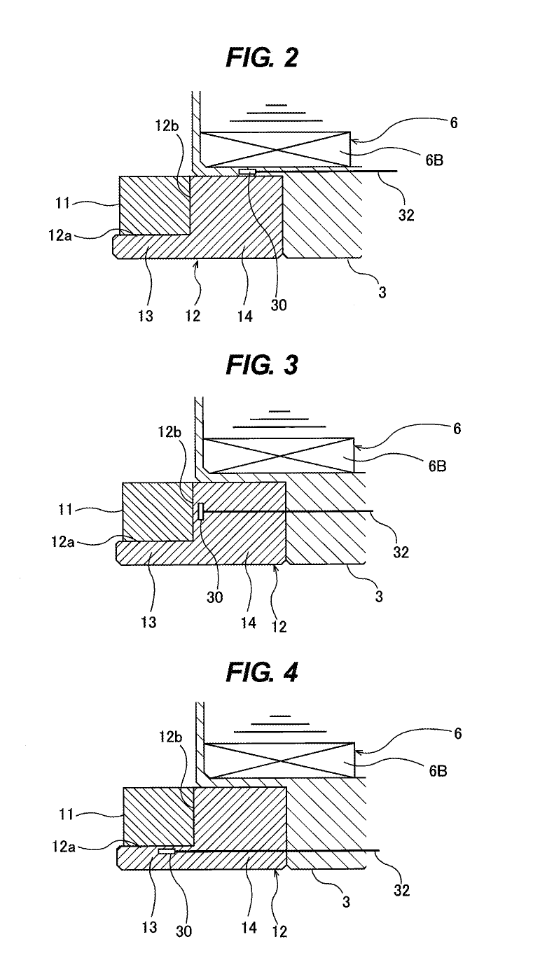

The vibration sensor 30 may be disposed at a position different from the position shown in FIG. 1 as long as the vibration sensor 30 can detect a vibration of the bearing assembly 10. In one embodiment, as shown in FIG. 2, the vibration sensor 30 may be embedded in the motor casing 3 at a position between the stationary-side bearing 12 and the motor stator 6.

In another embodiment, as shown in FIG. 3, the vibration sensor 30 may be embedded in the flange portion 14 of the stationary-side bearing 12. The vibration sensor 30 is located on the thrust surface 12b side of the stationary-side bearing 12, i.e. in the vicinity of the thrust surface 12b of the stationary-side bearing 12.

In yet another embodiment, as shown in FIG. 4, the vibration sensor 30 may be embedded in the cylindrical portion 13 of the stationary-side bearing 12. The vibration sensor 30 is located on the radial surface 12a side of the stationary-side bearing 12, i.e. in the vicinity of the radial surface 12a of the stationary-side bearing 12.

In yet another embodiment, the vibration sensor 30 may be disposed between the motor casing 3 and the stationary-side bearing 12. In particular, a recess (not shown) may be formed in that surface of the stationary-side bearing 12 which is in contact with the motor casing 3, and the vibration sensor 30 may be disposed in the recess. It is also possible to form a recess (not shown) in that surface of the motor casing 3 which is in contact with the stationary-side bearing 12, and to dispose the vibration sensor 30 in the recess such that the vibration sensor 30 is in contact with the stationary-side bearing 12.

As described above, the stationary-side bearing 12 is liquid-tightly secured to the motor casing 3; therefore, a liquid does not enter the gap between the stationary-side bearing 12 and the motor casing 3. Accordingly, the vibration sensor 30 does not contact a liquid if the vibration sensor 30 is disposed between the motor casing 3 and the stationary-side bearing 12.

A groove (not shown) may be formed in the surface of the motor casing 3, and the signal line 32 may be disposed in the groove. Thus, the signal line 32 may be connected to the vibration sensor 30 through the groove formed in the surface of the motor casing 3. Further, the signal line 32 may extend between the motor stator 6 and the end cover 4 without penetrating the end cover 4.

As described above, if foreign matter, which has entered the bearing assembly 10, clogs the gap in the bearing assembly 10, an abnormal vibration of the bearing assembly 10 may occur. A vibration of the bearing assembly 10, detected by the vibration sensor 30, is converted into an electrical signal and sent to the controller 29. The controller 29 is configured to measure the vibration detected by the vibration sensor 30 and calculate, from the measured vibration, the rate of change in the vibration of the bearing assembly 10 per a predetermined period of time. In one embodiment, the controller 29 calculates the rate of change in the vibration per a predetermined period of time at intervals of the predetermined period of time.

The controller 29 is configured to determine the abnormal level of a vibration of the bearing assembly 10 based on the vibration detected by the vibration sensor 30. The abnormal level of a vibration can be defined, for example, as follows. Using a reference value, such as an average value, which has been obtained from vibration during normal operation of the motor pump 50, the controller 29 determines the abnormal level of a vibration of the bearing assembly 10 when the rate of change in the vibration has exceeded the reference value a predetermined number of times. In one embodiment, the controller 29 may determine the abnormal level of a vibration of the bearing assembly 10 when the rate of change in the vibration becomes higher than a predetermined set value. The reference value and the set value may be the same value or different values.

In another embodiment, the controller 29 may measure a vibration of the bearing assembly 10 at intervals of a predetermined period of time after the start of operation of the motor pump 50, and may determine the abnormal level of a vibration of the bearing assembly 10 when a deviation of a current measured vibration value from a past measured vibration value becomes higher than a specified value. In this case, the deviation is regarded as the rate of change in the vibration. In yet another embodiment, the controller 29 may determine the abnormal level of a vibration based on the deviation amount or on the number of times the deviation has exceeded a predetermined acceptable value. The specified value and the acceptable value may be the same value or different values.

Based on the rate of change in a vibration of the bearing assembly 10, the controller 29 determines the abnormal level of the vibration, i.e. whether the gap in the bearing assembly 10 (more specifically the gap between the rotation-side bearing 11 and the stationary-side bearing 12) is clogged with foreign matter. The rate of change in the vibration is substantially 0 when the gap is not clogged with foreign matter.

The bearing assembly 10 vibrates vigorously when foreign matter, which has entered the bearing assembly 10, clogs the gap in the bearing assembly 10. The vibration sensor 30 detects the vigorous vibration, while the controller 29 calculates the rate of change in the vibration of the bearing assembly 10 based on the vibration detected by the vibration sensor 30, and compares the calculated rate of change in the vibration with a predetermined threshold value. As used herein, a predetermined threshold value is a general term for the above-described values (the number of times the rate of change in the vibration has exceeded the reference value, the set value, the specified value, the number of times the deviation has exceeded the acceptable value, the deviation amount, etc.).

When the calculated rate of change in the vibration is higher than the threshold value, the controller 29 determines the abnormal level of the vibration, and stops the operation of the motor pump 50, i.e. stops the supply of electric current to the motor stator 6. In this embodiment, the controller 29 issues a command to the inverter device 26 to stop the supply of electric current to the motor stator 6. The controller 29 may issue an alarm when stopping the operation of the motor pump 50. Alternatively, the controller 29 may solely issue an alarm.

As described above, according to this embodiment, the controller 29 can perform at least one of the operation to stop the operation of the motor pump 50 and the operation to issue an alarm. This can prevent damage to the bearing assembly 10 and a failure of the motor pump 50. Further, when the gap between the impeller 1 and the motor casing 3 is clogged with foreign matter, the controller 29 can perform the same operation as the above-described operation.

When foreign matter clogs the gap in the bearing assembly 10 (and/or the gap between the impeller 1 and the motor casing 3), the load on the impeller 1 increases, and the electric current supplied to the motor stator 6 increases. The controller 29 may be configured to monitor the electric current supplied to the motor stator 6, and to calculate the rate of change in the electric current per a predetermined period of time. In one embodiment, the controller 29 calculates the rate of change in the electric current per a predetermined period of time (e.g. one month) at intervals of the predetermined period of time.

The controller 29 is configured to determine the abnormal level of the electric current based on the electric current supplied to the motor stator 6. The abnormal level of the electric current can be defined, for example, as follows. Using a reference value, such as an average value, which has been obtained from current values during normal operation of the motor pump 50, the controller 29 determines the abnormal level of the electric current when the rate of change in the electric current has exceeded the reference value a predetermined number of times. In one embodiment, the controller 29 may determine the abnormal level of the electric current when the rate of change in the electric current becomes higher than a predetermined set value. The reference value and the set value may be the same value or different values.

In another embodiment, the controller 29 may measure current values at intervals of a predetermined period of time after the start of operation of the motor pump 50, and may determine the abnormal level of the electric current when a deviation of a current measured current value from a past measured current value becomes higher than a specified value. In this case, the deviation is regarded as the rate of change in the electric current. In yet another embodiment, the controller 29 may determine the abnormal level of the electric current based on the deviation amount or on the number of times the deviation has exceeded a predetermined acceptable value. The specified value and the acceptable value may be the same value or different values.

Based on the rate of change in the electric current, the controller 29 determines the abnormal level of the electric current, i.e. whether the gap in the bearing assembly 10 (more specifically the gap between the rotation-side bearing 11 and the stationary-side bearing 12) is clogged with foreign matter. The rate of change in the electric current is substantially 0 when the gap is not clogged with foreign matter.

The electric current supplied to the motor stator 6 increases when foreign matter, which has entered the bearing assembly 10, clogs the gap in the bearing assembly 10. The controller 29 compares the rate of change in the electric current with a predetermined threshold value. As used herein, a predetermined threshold value is a general term for the above-described values (the number of times the rate of change in the electric current has exceeded the reference value, the set value, the specified value, the number of times the deviation has exceeded the acceptable value, the deviation amount, etc.).

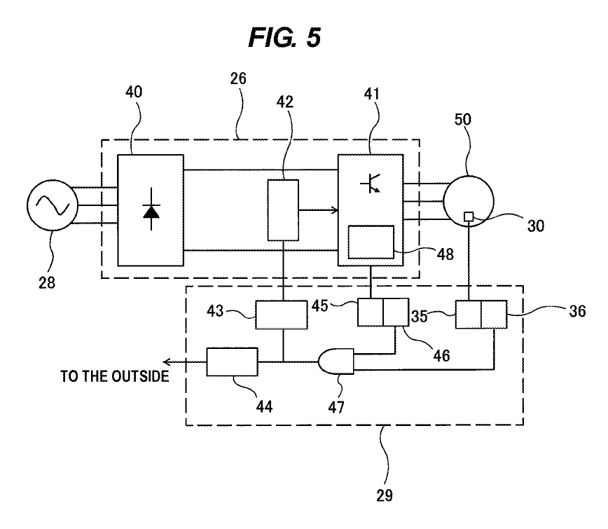

FIG. 5 is a schematic view showing the overall construction of the pump apparatus. As shown in FIG. 5, the inverter device 26 includes a converter section 40 for converting an AC power, supplied from the power source 28, into a DC power, an inverter section 41 for converting the DC power into an AC power having a desired frequency, and a drive control section 42 for sending to the inverter section 41 a signal instructing an on/off operation of a switching element of the inverter section 41. The inverter section 41 is provided with a current detector 48 for detecting an electric current supplied to the motor stator 6.

The controller 29 includes a storage device 35 for storing the calculated rate of change in the vibration, a comparator 36 for comparing the rate of change in the vibration, stored in the storage device 35, with a predetermined threshold value (first threshold value), a storage device 45 connected to the current detector 48 of the inverter section 41 of the inverter device 26, and a comparator 46 for comparing the rate of change in the electric current, stored in the storage device 45, with a predetermined threshold value (second threshold value). The storage device 45 is configured to store the calculated rate of change in the electric current.

The controller 29 further includes a sensor signal processor 47 connected to the comparators 36, 46, a control section 43 for controlling the operation of the drive control section 42 of the inverter device 26, and an emergency signal transmitter 44 for triggering an alarm. The comparators 36, 46 are connected to the input side of the sensor signal processor 47, while the control section 43 and the emergency signal transmitter 44 are connected to the output side of the sensor signal processor 47. The control section 43 is configured to send a start-up signal and a stop signal for the motor pump 50 to the drive control section 42.

The sensor signal processor 47 is configured to output an abnormality signal when the rate of change in the vibration is higher than a predetermined threshold value (first threshold value), and the rate of change in the electric current increases and exceeds a predetermined threshold value (second threshold value). Upon receipt of the abnormality signal outputted from the sensor signal processor 47, the control section 43 issues a command to the drive control section 42, and the drive control section 42 stops the supply of electric current to the motor stator 6. In this manner, the controller 29 stops the operation of the motor pump 50, i.e. stops the rotation of the impeller 1. The emergency signal transmitter 44, upon receipt of the abnormality signal outputted from the sensor signal processor 47, issues an alarm.

According to this embodiment, based on the rate of change in the vibration and the rate of change in the electric current, the controller 29 performs at least one of the operation to stop the operation of the motor pump 50 and the operation to issue an alarm. Therefore, the controller 29 can more securely determine clogging of the gap in the bearing assembly 10 (and/or the gap between the impeller 1 and the motor casing 3) with foreign matter.

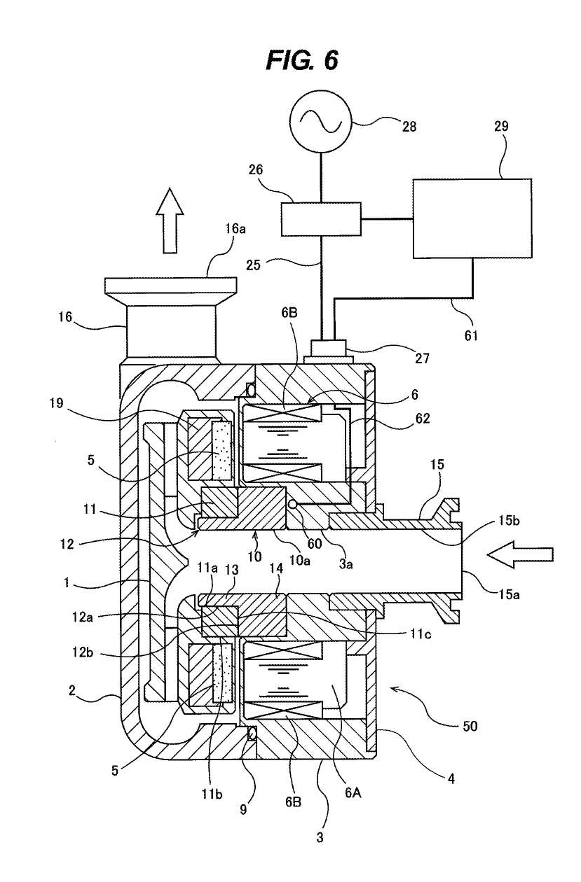

FIG. 6 is a diagram showing another embodiment of a pump apparatus. In this embodiment, the same symbols as used in the above-described embodiment are used for the same or equivalent components or members, and a duplicate description thereof is omitted. As shown in FIG. 6, it is possible to use a sound sensor (microphone) 60 instead of the vibration sensor 30. The sound sensor 60 is connected to the controller 29 via a signal line 62 and a sensor cable 61. When foreign matter clogs the gap in the bearing assembly 10, the bearing assembly 10 generates an abnormal noise (more specifically an abnormally loud noise different from a noise during normal operation of the motor pump 50 and/or a noise having a frequency different from the frequency of a noise during normal operation of the motor pump 50).

The sound sensor 60 captures a sound generated by the bearing assembly 10, and converts the sound into an electrical signal. The sound is transmitted as an electrical signal to the controller 29. The controller 29 measures the sound pressure level and the frequency of the sound captured by the sound sensor 60, and calculates the rate of change in the sound pressure level per a predetermined period of time and the rate of change in the frequency per a predetermined period of time. The controller 29 thus calculates the rate of change in the sound. When the rate of change in the sound is higher than a predetermined threshold value, the controller 29 performs at least one of the operation to stop the supply of electric current to the motor stator 6 and the operation to issue an alarm. The predetermined threshold value has the same meaning as the above-described values.

The controller 29 may perform the above-described operation(s) when the rate of change in the sound is higher than a predetermined threshold value (first threshold value), and the rate of change in the electric current increases and exceeds a predetermined threshold value (second threshold value).

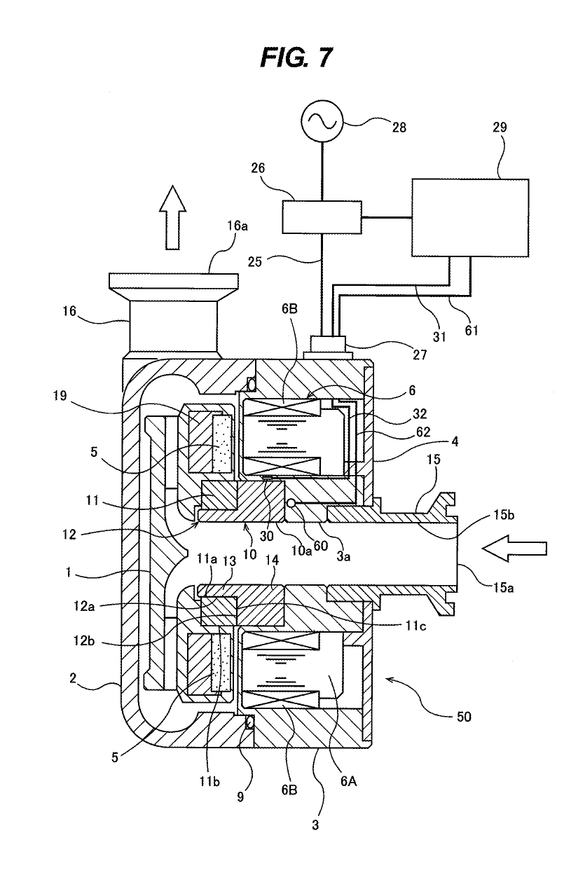

FIG. 7 is a diagram showing yet another embodiment of a pump apparatus. In this embodiment, the same symbols as used in the above-described embodiments are used for the same or equivalent components or members, and a duplicate description thereof is omitted. As shown in FIG. 7, it is possible to use both the vibration sensor 30 and the sound sensor 60. In this case, the controller 29 may perform the above-described operation(s) when the calculated rate of change in the vibration is higher than a predetermined threshold value (first threshold value), and the calculated rate of change in the sound is higher than a predetermined threshold value (second threshold value).

The controller 29 may perform the above-described operation(s) when the rate of change in the vibration is higher than a predetermined threshold value (first threshold value), the rate of change in the sound is higher than a predetermined threshold value (second threshold value), and the rate of change in the electric current increases and exceeds a predetermined threshold value (third threshold value).

Yet another embodiment of the present invention will now be described with reference to the drawings. In the drawings, the same symbols are used for the same or equivalent components or elements, and a duplicate description thereof is omitted.

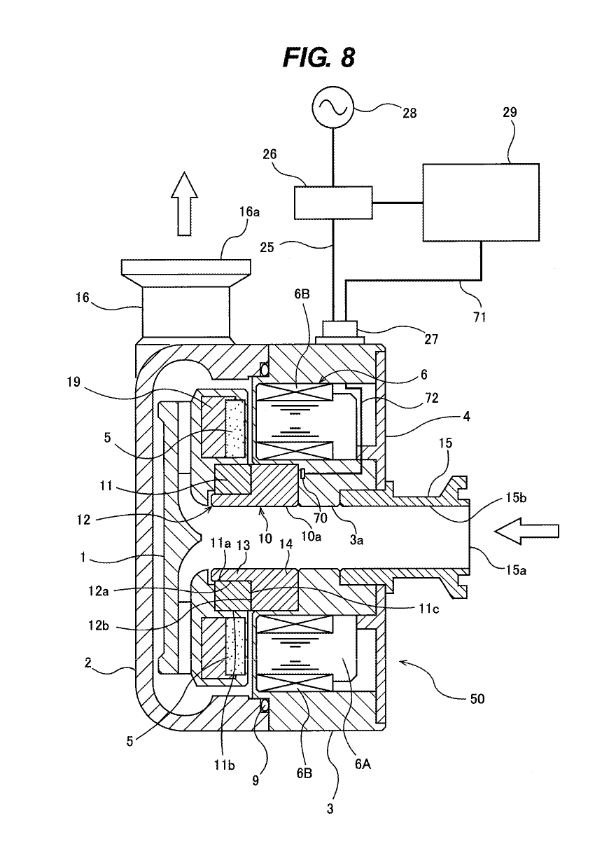

FIG. 8 is a cross-sectional view showing yet another embodiment of a pump apparatus. The pump apparatus includes a motor pump 50 comprised of a motor and a pump which are constructed integrally. The motor pump 50 shown in FIG. 8 is a canned motor pump equipped with an axial gap-type PM motor. As shown in FIG. 8, the motor pump 50 includes an impeller 1 in which a plurality of permanent magnets 5 are embedded, a motor stator 6 which generates a magnetic force acting on the permanent magnets 5, a pump casing 2 which houses the impeller 1, a motor casing 3 which houses the motor stator 6, an end cover 4 which closes the open end of the motor casing 3, and a bearing assembly 10 which supports the radial load and the thrust load of the impeller 1.

The motor stator 6 and the bearing assembly 10 are disposed on the suction side of the impeller 1. Though the plurality of permanent magnets 5 are provided in this embodiment, the present invention is not limited to this embodiment: a single permanent magnet having a plurality of magnetic poles may be used. In particular, it is possible to use an annular magnetic pole having a plurality of magnetic poles which have been magnetized into alternating S poles and N poles.

An O-ring 9 as a sealing member is provided between the pump casing 2 and the motor casing 3. The provision of the O-ring 9 can prevent leakage of a liquid from between the pump casing 2 and the motor casing 3.

A suction port 15 having a suction opening 15a is liquid-tightly coupled to the motor casing 3. The suction port 15 has a flange-like shape, and is connected to a not-shown suction line. Liquid flow passages 15b, 3a, 10a are formed in the centers of the suction port 15, the motor casing 3 and the bearing assembly 10, respectively. The liquid flow passages 15b, 3a, 10a are connected in a line and constitute a liquid flow passage extending from the suction opening 15a to the liquid inlet of the impeller 1.

The motor pump 50 of this embodiment is a canned motor pump equipped with an axial gap-type PM motor having the permanent magnets 5 and the motor stator 6, disposed along the liquid flow passages 15b, 3a, 10a.

A discharge port 16 having a discharge opening 16a is provided on a side surface of the pump casing 2. A liquid, whose pressure has been raised by the rotating impeller 1, is discharged through the discharge opening 16a. The motor pump 50 of this embodiment is a so-called end-top motor pump in which the suction opening 15a and the discharge opening 16a are mutually orthogonal.

The impeller 1 is formed of a smooth and wear-resistant non-magnetic material. For example, resins such as PTFE (polytetrafluoroethylene) and PPS (polyphenylene sulfide), and ceramics are preferably used. The pump casing 2 and the motor casing 3 (including the end cover 4) may be formed of the same material as that of the impeller 1.

The impeller 1 is rotatably supported by the single bearing assembly 10. The bearing assembly 10 is a plain bearing (dynamic bearing) using the dynamic pressure of a fluid. The bearing assembly 10 is comprised of a combination of a rotation-side bearing 11 and a stationary-side bearing 12 which are in loose engagement with each other. The rotation-side bearing 11 is secured to the impeller 1 and disposed such that it surrounds the fluid inlet of the impeller 1. The stationary-side bearing 12 is secured to the motor casing 3 and disposed on the suction side of the rotation-side bearing 11. The stationary-side bearing 12 includes a cylindrical portion 13, and a flange portion 14 extending outward from the cylindrical portion 13. The cylindrical portion 13 extends in the axial direction of the rotation-side bearing 11. The cylindrical portion 13 and the flange portion 14 are constructed integrally.

The cylindrical portion 13 has a radial surface (outer peripheral surface) 12a that supports the radial load of the impeller 1, while the flange portion 14 has a thrust surface (side surface) 12b that supports the thrust load of the impeller 1. The radial surface 12a is parallel to the axis of the impeller 1, while the thrust surface 12b is perpendicular to the axis of the impeller 1. The rotation-side bearing 11 is disposed around the cylindrical portion 13 of the stationary-side bearing 12.

The rotation-side bearing 11 has an inner surface 11a facing the radial surface 12a of the stationary-side bearing 12, an outer surface 11b opposite the inner surface 11a, and a side surface 11c extending between the inner surface 11a and the outer surface 11b. The side surface 11c of the rotation-side bearing 11 faces the thrust surface 12b of the stationary-side bearing 12. A slight gap is formed between the inner surface 11a of the rotation-side bearing 11 and the radial surface 12a, and between the side surface 11c of the rotation-side bearing 11 and the thrust surface 12b. A not-shown sealing member is provided between the rotation-side bearing 11 and the impeller 1, so that the rotation-side bearing 11 is liquid-tightly secured to the impeller 1. Similarly, a not-shown sealing member is provided between the stationary-side bearing 12 and the motor casing 3, so that the stationary-side bearing 12 is liquid-tightly secured to the motor casing 3.

Part of a fluid, discharged from the impeller 1, is directed to the bearing assembly 10 through a slight gap between the impeller 1 and the motor casing 3. When the rotation-side bearing 11 rotates together with the impeller 1, a dynamic pressure of the fluid is generated between the rotation-side bearing 11 and the stationary-side bearing 12, whereby the impeller 1 is supported by the bearing assembly 10 in a non-contact manner. Since the stationary-side bearing 12 supports the rotation-side bearing 11 with the radial surface 12a and the thrust surface 12b which are mutually orthogonal, tilting of the impeller 1 is restricted by the bearing assembly 10.

The motor stator 6 includes a stator core 6A and a plurality of stator coils 6B. The stator coils 6B are arranged in a ring. The impeller 1 and the motor stator 6 are arranged concentrically with the bearing assembly 10 and the suction opening 15a.

Leads 25 are connected to the stator coils 6B, and a connector 27 is mounted to the exterior surface of the motor casing 3. The stator coils 6B are connected to an inverter device 26 via the leads 25 and the connector 27. The inverter device 26 is connected to a power source 28, and is also connected to a controller 29 which controls the operation of the inverter device 26.

The inverter device 26 supplies electric current to the stator coils 6B of the motor stator 6 to generate a rotating magnetic field in the motor stator 6. The rotating magnetic field acts on the permanent magnets 5 embedded in the impeller 1, and rotationally drives the impeller 1. The torque of the impeller 1 depends on the intensity of the electric current supplied to the motor stator 6. The electric current supplied to the motor stator 6 is approximately constant as long as the load applied to the impeller 1 is constant.

When the impeller 1 rotates, a liquid is directed from the suction opening 15a to the liquid inlet of the impeller 1. The pressure of the liquid is raised by the rotation of the impeller 1, and the liquid is discharged from the discharge opening 16a. While the impeller 1 is transferring the liquid, the back surface of the impeller 1 is pressed toward the suction side (i.e. toward the suction opening 15a) by the liquid whose pressure has been raised. Since the bearing assembly 10 is disposed on the suction side of the impeller 1, the bearing assembly 10 supports the thrust load of the impeller 1 from the suction side.

If the motor pump is operated in the absence of a liquid, no liquid is introduced into the gap between the rotation-side bearing 11 and the stationary-side bearing 12, and therefore the rotation-side bearing 11 will slide on the stationary-side bearing 12, and frictional heat will be generated in the bearing assembly 10. When the operation of the motor pump in such a dry state is continued, the temperature of the bearing assembly 10 continues to rise because it is not cooled by a liquid. This may cause seizure of the bearing assembly 10, which could result in damage to the bearing assembly 10 and a failure of the motor pump 50. In view of this, as shown in FIG. 8, a temperature sensor (temperature detector) 70 for detecting the temperature of the bearing assembly 10 is disposed in the motor casing 3 adjacent to the bearing assembly 10.

In this embodiment, the temperature sensor 70 is embedded in the motor casing 3 at a position between the stationary-side bearing 12 and the end cover 4 and nearer to the stationary-side bearing 12. In particular, the temperature sensor 70 is located in the vicinity of the stationary-side bearing 12. The temperature sensor 70, located close to the stationary-side bearing 12, can securely detect a vibration of the bearing assembly 10.

In order to more securely transmit the temperature of the bearing assembly 10 to the temperature sensor 70, the bearing assembly 10 is preferably made of a material having a high thermal conductivity. For example, the bearing assembly 10 is made of a material such as a ceramic or a metal.

The single temperature sensor 70 is used in this embodiment. However, the number of temperature sensors 70 is not limited to one: two or more temperature sensors may be used. In the case of using a plurality of temperature sensors 70, the temperature sensors 70 may be disposed at regular intervals in the circumferential direction of the stationary-side bearing 12.

As shown in FIG. 8, the temperature sensor 70 is connected to a signal line 72 which, in turn, is connected a sensor cable 71 via the connector 27. The sensor cable 71 is connected to the controller 29. Thus, the temperature sensor 70 is connected to the controller 29 via the signal line 72 and the sensor cable 71. The temperature sensor 70 may be connected to the controller 29 by a single wire.

In this embodiment, the temperature sensor 70 is disposed in the motor casing 3, and the signal line 72 is connected to the connector 27 through the motor casing 3, the end cover 4 and the space in which the motor stator 6 is disposed. According to this embodiment, the temperature sensor 70 and the signal line 72 are disposed in an area where there is no fear of entry of a liquid being transferred by the operation of the motor pump 50. Therefore, the temperature sensor 70 can be installed relatively easily without the need for special waterproofing.

Further, according to this embodiment, the signal line 72 extends in the space in which the motor stator 6 is disposed, and therefore the leads 25 and the sensor cable 71 can be easily connected to the inverter device 26 and the controller 29, respectively, via the connector 27.

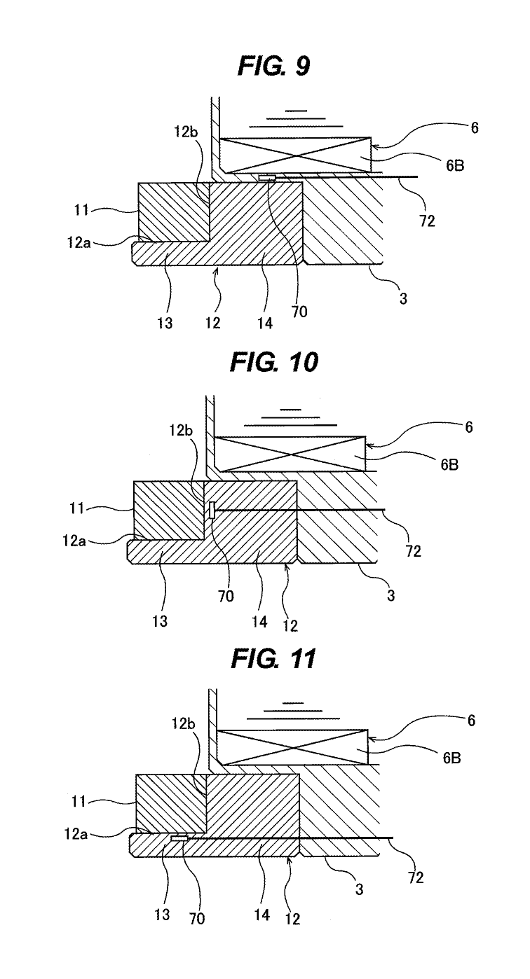

The temperature sensor 70 may be disposed at a position different from the position shown in FIG. 8. In one embodiment, as shown in FIG. 9, the temperature sensor 70 may be embedded in the motor casing 3 at a position between the stationary-side bearing 12 and the motor stator 6.

In another embodiment, as shown in FIG. 10, the temperature sensor 70 may be embedded in the flange portion 14 of the stationary-side bearing 12. The temperature sensor 70 is located on the thrust surface 12b side of the stationary-side bearing 12, i.e. in the vicinity of the thrust surface 12b of the stationary-side bearing 12.

In yet another embodiment, as shown in FIG. 11, the temperature sensor 70 may be embedded in the cylindrical portion 13 of the stationary-side bearing 12. The temperature sensor 70 is located on the radial surface 12a side of the stationary-side bearing 12, i.e. in the vicinity of the radial surface 12a of the stationary-side bearing 12.

In yet another embodiment, the temperature sensor 70 may be disposed between the motor casing 3 and the stationary-side bearing 12. In particular, a recess (not shown) may be formed in that surface of the stationary-side bearing 12 which is in contact with the motor casing 3, and the temperature sensor 70 may be disposed in the recess. It is also possible to form a recess (not shown) in that surface of the motor casing 3 which is in contact with the stationary-side bearing 12, and to dispose the temperature sensor 70 in the recess such that the temperature sensor 70 is in contact with the stationary-side bearing 12.

As described above, the stationary-side bearing 12 is liquid-tightly secured to the motor casing 3; therefore, a liquid does not enter the gap between the stationary-side bearing 12 and the motor casing 3. Accordingly, the temperature sensor 70 does not contact a liquid if the temperature sensor 70 is disposed between the motor casing 3 and the stationary-side bearing 12.

A groove (not shown) may be formed in the surface of the motor casing 3, and the signal line 72 may be disposed in the groove. Thus, the signal line 72 may be connected to the temperature sensor 70 through the groove formed in the surface of the motor casing 3. Further, the signal line 72 may extend between the motor stator 6 and the end cover 4 without penetrating the end cover 4.

As described above, if the motor pump 50 is operated in a dry state, frictional heat will be generated in the bearing assembly 10. The temperature of the bearing assembly 10, detected by the temperature sensor 70, is converted into an electrical signal and sent to the controller 29. The controller 29 is configured to measure the temperature detected by the temperature sensor 70 and calculate, from the measured temperature, the rate of change in the temperature of the bearing assembly 10 per a predetermined period of time. In one embodiment, the controller 29 calculates the rate of change in the temperature per a predetermined period of time at intervals of the predetermined period of time.

The controller 29 is configured to determine the abnormal level of the temperature of the bearing assembly 10 based on the temperature detected by the temperature sensor 70. The abnormal level of the temperature can be defined, for example, as follows. Using a reference value, such as an average value, which has been obtained from the temperature during normal operation of the motor pump 50, the controller 29 determines the abnormal level of the temperature of the bearing assembly 10 when the rate of change in the temperature has exceeded the reference value a predetermined number of times. In one embodiment, the controller 29 may determine the abnormal level of the temperature of the bearing assembly 10 when the rate of change in the temperature becomes higher than a predetermined set value. The reference value and the set value may be the same value or different values.

In another embodiment, the controller 29 may measure the temperature of the bearing assembly 10 at intervals of a predetermined period of time after the start of operation of the motor pump 50, and may determine the abnormal level of the temperature of the bearing assembly 10 when a deviation of a current measured temperature value from a past measured temperature value becomes higher than a specified value. In this case, the deviation is regarded as the rate of change in the temperature. In yet another embodiment, the controller 29 may determine the abnormal level of the temperature based on the deviation amount or on the number of times the deviation has exceeded a predetermined acceptable value. The specified value and the acceptable value may be the same value or different values.

Based on the rate of change in the temperature of the bearing assembly 10, the controller 29 determines the abnormal level of the temperature of the bearing assembly 10, i.e. whether frictional heat has been generated in the bearing assembly 10. In other words, the controller 29 determines whether the motor pump 50 has been operated in a dry state. The rate of change in the temperature is substantially 0 when the motor pump 50 is transferring a liquid in an appropriate fashion, i.e. when a liquid is appropriately present in the gap between the rotation-side bearing 11 and the stationary-side bearing 12.

As described above, if the operation of the motor pump 50 is continued in the absence of a liquid in the bearing assembly 10, the temperature of the bearing assembly 10 rises abnormally due to frictional heat. The temperature sensor 70 detects the abnormal temperature, while the controller 29 calculates the rate of change in the temperature of the bearing assembly 10 based on the temperature detected by the temperature sensor 70, and compares the calculated rate of change in the temperature with a predetermined threshold value. As used herein, a predetermined threshold value is a general term for the above-described values (the number of times the rate of change in the temperature has exceeded the reference value, the set value, the specified value, the number of times the deviation has exceeded the acceptable value, the deviation amount, etc.).

When the calculated rate of change in the temperature is higher than the threshold value, the controller 29 determines the abnormal level of the temperature, and stops the operation of the motor pump 50, i.e. stops the supply of electric current to the motor stator 6. In this embodiment, the controller 29 issues a command to the inverter device 26 to stop the supply of electric current to the motor stator 6. The controller 29 may issue an alarm when stopping the operation of the motor pump 50. Alternatively, the controller 29 may solely issue an alarm.

According to this embodiment, the temperature sensor 70 can detect a rise in the temperature of the bearing assembly 10 due to frictional heat, and the controller 29 can perform at least one of the operation to stop the operation of the motor pump 50 and the operation to issue an alarm. Thus, the use of the temperature sensor 70 can directly prevent damage to the bearing assembly 10 and a failure of the motor pump 50 without using an indirect means, such as monitoring of the flow rate of a liquid being transferred by the motor pump 50.

When the motor pump 50 is operated in a dry state, the power of the motor pump 50 decreases, and therefore the electric current supplied to the motor stator 6 decreases: the load on the impeller 1 is at a minimum, and therefore the electric current is at a minimum when there is no liquid in the motor pump 50. The controller 29 may be configured to monitor the electric current supplied to the motor stator 6, and to calculate the rate of change in the electric current per a predetermined period of time. In one embodiment, the controller 29 calculates the rate of change in the electric current per a predetermined period of time (e.g. one month) at intervals of the predetermined period of time.

The controller 29 is configured to determine the abnormal level of the electric current based on the electric current supplied to the motor stator 6. The abnormal level of the electric current can be defined, for example, as follows. Using a reference value, such as an average value, which has been obtained from current values during normal operation of the motor pump 50, the controller 29 determines the abnormal level of the electric current when the rate of change in the electric current has been lower than the reference value a predetermined number of times. In one embodiment, the controller 29 may determine the abnormal level of the electric current when the rate of change in the electric current becomes lower than a predetermined set value. The reference value and the set value may be the same value or different values.

In another embodiment, the controller 29 may measure current values at intervals of a predetermined period of time after the start of operation of the motor pump 50, and may determine the abnormal level of the electric current when a deviation of a current measured current value from a past measured current value becomes lower than a specified value. In this case, the deviation is regarded as the rate of change in the electric current. In yet another embodiment, the controller 29 may determine the abnormal level of the electric current based on the deviation amount or on the number of times the deviation has been lower than a predetermined acceptable value. The specified value and the acceptable value may be the same value or different values.

Based on the rate of change in the electric current, the controller 29 determines the abnormal level of the electric current, i.e. whether the motor pump 50 has been operated in a dry state. The rate of change in the electric current is substantially 0 when a liquid is appropriately present in the gap between the rotation-side bearing 11 and the stationary-side bearing 12.

The electric current supplied to the motor stator 6 decreases when the motor pump 50 is operated in a dry state. The controller 29 compares the rate of change in the electric current with a predetermined threshold value. As used herein, a predetermined threshold value is a general term for the above-described values (the number of times the rate of change in the electric current has been lower than the reference value, the set value, the specified value, the number of times the deviation has been lower than the acceptable value, the deviation amount, etc.).

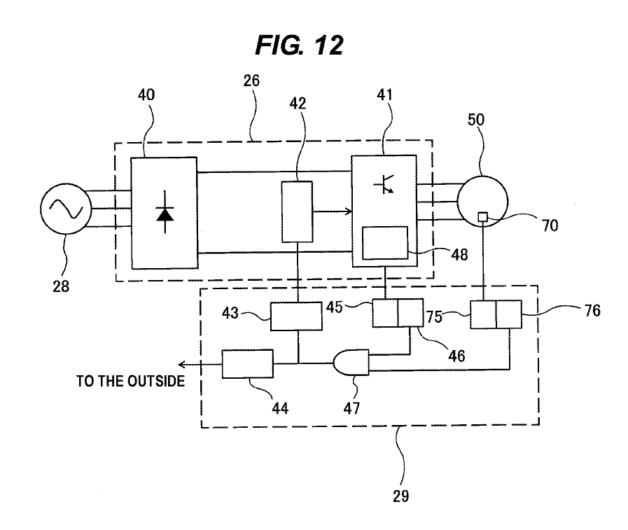

FIG. 12 is a schematic view showing the overall construction of the pump apparatus. As shown in FIG. 12, the inverter device 26 includes a converter section 40 for converting an AC power, supplied from the power source 28, into a DC power, an inverter section 41 for converting the DC power into an AC power having a desired frequency, and a drive control section 42 for sending to the inverter section 41 a signal instructing an on/off operation of a switching element of the inverter section 41. The inverter section 41 is provided with a current detector 48 for detecting an electric current supplied to the motor stator 6.

The controller 29 includes a storage device 75 for storing the calculated rate of change in the temperature, a comparator 76 for comparing the rate of change in the temperature, stored in the storage device 75, with a predetermined threshold value, a storage device 45 connected to the current detector 48 of the inverter section 41 of the inverter device 26, and a comparator 46 for comparing the rate of change in the electric current, stored in the storage device 45, with a predetermined threshold value. The storage device 45 is configured to store the calculated rate of change in the electric current.

The controller 29 further includes a sensor signal processor 47 connected to the comparators 76, 46, a control section 43 for controlling the operation of the drive control section 42 of the inverter device 26, and an emergency signal transmitter 44 for triggering an alarm. The comparators 76, 46 are connected to the input side of the sensor signal processor 47, while the control section 43 and the emergency signal transmitter 44 are connected to the output side of the sensor signal processor 47. The control section 43 is configured to send a start-up signal and a stop signal for the motor pump 50 to the drive control section 42.

The sensor signal processor 47 is configured to output an abnormality signal when the rate of change in the temperature is higher than a predetermined threshold value (first threshold value), and the rate of change in the electric current decreases to below a predetermined threshold value (second threshold value). Upon receipt of the abnormality signal outputted from the sensor signal processor 47, the control section 43 issues a command to the drive control section 42, and the drive control section 42 stops the supply of electric current to the motor stator 6. In this manner, the controller 29 stops the operation of the motor pump 50, i.e. stops the rotation of the impeller 1. The emergency signal transmitter 44, upon receipt of the abnormality signal outputted from the sensor signal processor 47, issues an alarm.

According to this embodiment, based on the rate of change in the temperature and the rate of change in the electric current, the controller 29 performs at least one of the operation to stop the operation of the motor pump 50 and the operation to issue an alarm. In some cases, the motor pump 50 transfers a high-temperature liquid. It is possible that when the high-temperature liquid is introduced into the gap between the rotation-side bearing 11 and the stationary-side bearing 12, the temperature sensor 70 may detect an abnormal rise in the temperature of the bearing assembly 10, leading to an improper operation of the controller 29. According to this embodiment, the controller 29 can more securely determine the generation of frictional heat in the bearing assembly 10.

Yet another embodiment of the present invention will now be described with reference to the drawings. In the drawings, the same symbols are used for the same or equivalent components or elements, and a duplicate description thereof is omitted.

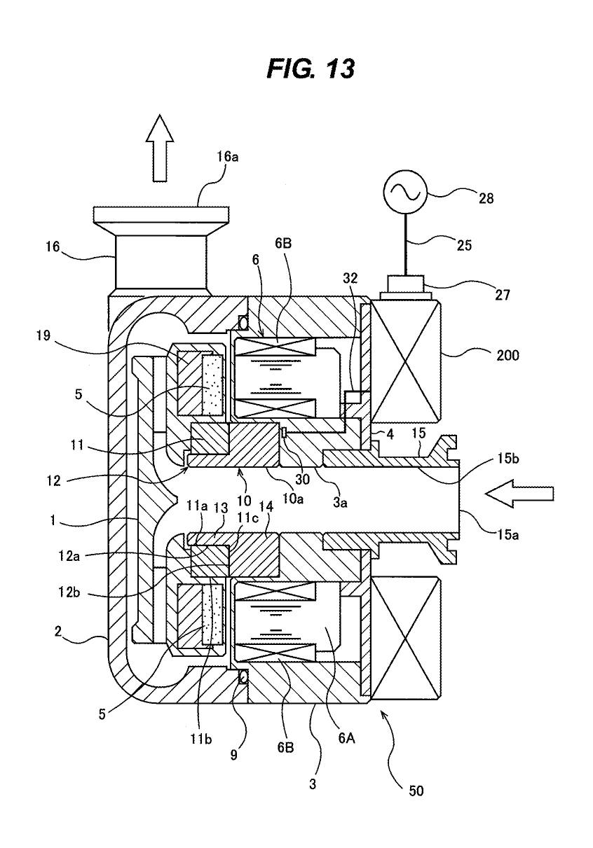

FIG. 13 is a cross-sectional view showing yet another embodiment of a pump apparatus. In the embodiment shown in FIG. 13, the pump apparatus includes a control unit 200 secured to the end cover 4. The control unit 200 includes the inverter device 26 and the controller 29. The depiction of the inverter device 26 and the controller 29 is omitted in FIG. 13. The control unit 200 having an annular shape is disposed around and concentrically with the suction port 15 mounted to the end cover 4. The control unit 200 is connected to the power source 28 via the connector 27 and the leads 25.

The pump casing 2, the motor casing 3 and the control unit 200 are disposed in a line along the liquid flow passages 15b, 3a, 10a which constitute a liquid flow passage extending from the suction opening 15a to the liquid inlet of the impeller 1.

In the embodiment shown in FIG. 13, the pump apparatus, including the control unit 200 secured to the end cover 4, is equipped with the vibration sensor 30 embedded in the motor casing 3 at a position between the stationary-side bearing 12 and the end cover 4 and nearer to the stationary-side bearing 12. The signal line 32, to which the vibration sensor 30 is connected, is connected to the controller 29 of the control unit 200. However, the structure of the pump apparatus, including the control unit 200 secured to the end cover 4 and disposed adjacent to the motor stator 6, can be applied also to the embodiments shown in FIGS. 2, 3, 4, 6, 7, 8, 9, 10 and 11.

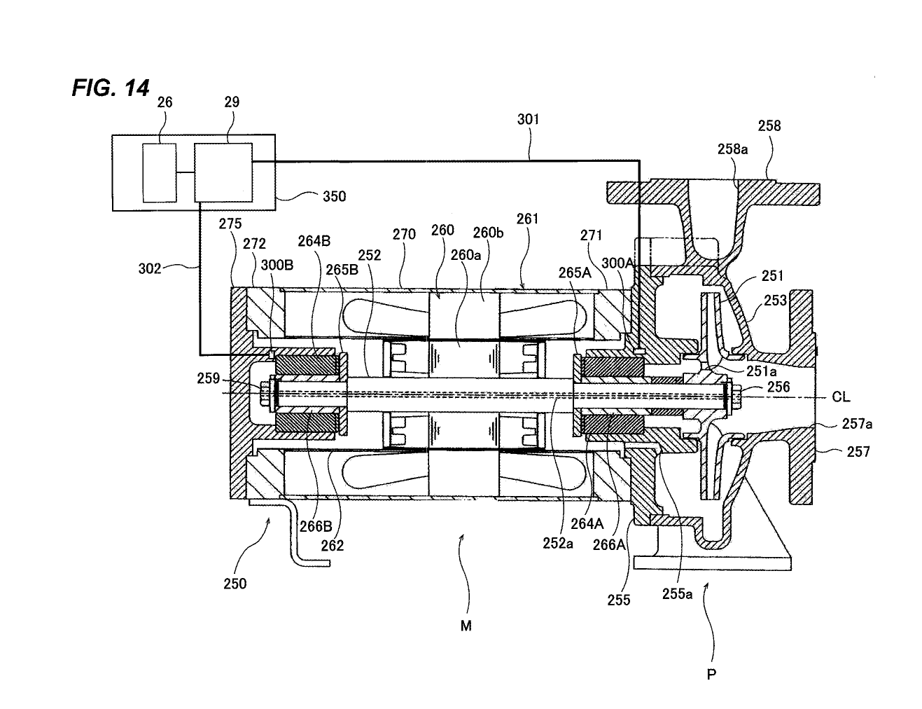

FIG. 14 is a cross-sectional view showing yet another embodiment of a pump apparatus. In this embodiment, the pump apparatus includes a canned motor pump 250. The canned motor pump 250 has a structure that allows internal circulation of a liquid.

As shown in FIG. 14, the canned motor pump 250 is composed of a pump section P and a motor section M. The pump section P includes an impeller 251 for transferring a liquid, a rotating shaft 252 to which the impeller 251 is secured and which has an axial through-hole 252a axially extending through the shaft 252, and a pump casing 253 which houses the impeller 251. The motor section M includes a motor 260 for rotating the rotating shaft 252, and a motor casing 261 which houses the motor 260. The pump casing 253 and the motor casing 261 are disposed linearly in the direction of the axis CL of the rotating shaft 252.

A casing cover 255 is liquid-tightly secured to a high pressure-side opening of the pump casing 253. The rotating shaft 252 extends through the casing cover 255, and the impeller 251 is secured to the front end of the rotating shaft 252 by means of a fastening tool 256. A fastening tool 259 is secured to the rear end of the rotating shaft 252. The fastening tools 256, 259 each have a communication hole communicating with the axial through-hole 252a of the rotating shaft 252.

The casing cover 255 has a fluid communication hole 255a for directing part of a liquid, which has been sucked into the pump casing 253, to the motor section M. The fluid communication hole 255a connects a space in which the motor 260 is disposed and the interior of the pump casing 253. Therefore, part of a liquid, whose pressure has been raised by the rotation of the impeller 251, is directed through the fluid communication hole 255a to the motor section M.

The pump casing 253 includes a suction port 257 having a suction opening 257a, and a discharge port 258 having a discharge opening 258a. A liquid is sucked from the suction opening 257a of the suction port 257 and discharged from the discharge opening 258a of the discharge port 258 by the rotation of the impeller 251.

The motor 260 includes a motor rotor 260a secured to the rotating shaft 252, and a motor stator 260b disposed around the motor rotor 260a. The inverter device 26 supplies electric current to the motor stator 260b to generate a rotating magnetic field in the motor stator 260b. The motor rotor 260a is rotated by the rotating magnetic field. The rotation of the motor rotor 260a rotates the impeller 251 via the rotating shaft 252.

The motor casing 261 includes a cylindrical motor frame 270 disposed such that it surrounds the motor stator 260b, frame side plates 271, 272 mounted at both ends of the motor frame 270, and an end cover 275 disposed on the opposite side of the motor 260 from the casing cover 255. The frame side plate 271 is secured to the casing cover 255, while the frame side plate 272 is secured to the end cover 275. The end cover 275 closes the opening of the frame side plate 272.

A cylindrical can 262 is disposed between the motor rotor 260a and the motor stator 260b such that it surrounds the motor rotor 260a. The motor stator 260b is disposed between the motor frame 270 and the can 262. The motor rotor 260a, the motor stator 260b and the can 262 are disposed concentrically.

The rotating shaft 252 is supported by bearings. In particular, in this embodiment the bearings are a first bearing (e.g. a plain bearing) 264A and a second bearing (e.g. a plain bearing) 264B, disposed on both sides of the motor rotor 260a. The rotating shaft 252 is rotatably supported by the bearings 264A, 264B. Thrust plates 265A, 265B having an annular shape, and shaft sleeves 266A, 266B having a cylindrical shape are secured to the rotating shaft 252 at positions on both sides of the motor 260. The thrust plates 265A, 265B and the shaft sleeves 266A, 266B may be referred to collectively herein as rotation-side members.

The bearing 264A is disposed adjacent to the pump casing 253, while the bearing 264B is disposed at a distance from the pump casing 253: the bearing 264B is disposed on the opposite side of the motor 260 from the bearing 264A. The bearing 264A is disposed between the shaft sleeve 266A and the casing cover 255, and mounted to the casing cover 255. Thus, the bearing 264A does not rotate together with the rotating shaft 252. A slight gap is formed between the bearing 264A and the shaft sleeve 266A, and a slight gap is formed between the bearing 264A and the thrust plate 265A.

The bearing 264B is disposed between the shaft sleeve 266B and the end cover 275, and mounted to the end cover 275. Thus, the bearing 264B does not rotate together with the rotating shaft 252. A slight gap is formed between the bearing 264B and the shaft sleeve 266B, and a slight gap is formed between the bearing 264B and the thrust plate 265B.

The flow of a liquid in the pump apparatus will now be described. Part of a liquid, which has been sucked into the pump casing 253, is directed through the fluid communication hole 255a to the motor section M. The liquid flows through the gap between the bearing 264A and the thrust plate 265A, and through the gap between the bearing 264A and the shaft sleeve 266A. In this manner, the liquid cools and lubricates the bearing 264A. The liquid is then returned to the interior of the impeller 251 through a through-hole 251a of the impeller 251.

Part of the liquid which has been directed to the motor section M passes through a slight gap between the motor rotor 260a and the can 262, and flows through the gap between the bearing 264B and the thrust plate 265B, and through the gap between the bearing 264B and the shaft sleeve 266B. In this manner, the liquid cools and lubricates the bearing 264B. The liquid is then returned to the interior of the pump casing 253 through the axial through-hole 252a of the rotating shaft 252.

As described above, if the liquid contains foreign matter, the foreign matter can clog the gaps between the bearings (namely the first bearing 264A and the second bearing 264B) and the rotation-side members (namely the thrust plates 265A, 265B and the shaft sleeves 266A, 266B). When the operation of the canned motor pump 250 is continued with the gap(s) clogged with foreign matter, the bearing(s) could be damaged. If the canned motor pump 250 is operated in the absence of a liquid being transferred, no liquid is introduced into the gaps between the bearings and the rotation-side members, and therefore bearings can directly contact the rotation-side members. When the operation of the canned motor pump 250 in such a state is continued, the rotation-side members will slide on the bearings, and frictional heat will be generated between the bearings and the rotation-side members. This may cause seizure of the bearings, which could result in damage to the bearings.

In view of this, as shown in FIG. 14, the pump apparatus is equipped with physical quantity sensors for detecting a physical quantity of the bearings. In particular, in this embodiment the physical quantity sensors are a first physical quantity sensor 300A embedded in the casing cover 255, and a second physical quantity sensor 300B embedded in the end cover 275.

The first physical quantity sensor 300A is disposed in the casing cover 255 at a position adjacent to the first bearing 264A. The second physical quantity sensor 300B is disposed in the end cover 275 at a position adjacent to the second bearing 264B. The first physical quantity sensor 300A and the second physical quantity sensor 300B may be disposed at positions different from those of FIG. 14 as long as the first physical quantity sensor 300A is embedded in the casing cover 255, and the second physical quantity sensor 300B is embedded in the end cover 275.

The first physical quantity sensor 300A and the second physical quantity sensor 300B each correspond to the vibration sensor 30, the sound sensor 60 or the temperature sensor 70 described above. A physical quantity of the bearings herein refers to a vibration of each bearing, a sound generated by each bearing or the temperature of each bearing.

The first physical quantity sensor 300A is selected from a vibration sensor for detecting a vibration of the first bearing 264A, a sound sensor for detecting a sound generated by the first bearing 264A, and a temperature sensor for detecting a temperature of the first bearing 264A. The second physical quantity sensor 300B is selected from a vibration sensor for detecting a vibration of the second bearing 264B, a sound sensor for detecting a sound generated by the second bearing 264B, and a temperature sensor for detecting a temperature of the second bearing 264B. Thus, the first physical quantity sensor 300A and the second physical quantity sensor 300B may detect different types of physical quantities or detect the same type of physical quantity.

In this embodiment, the pump apparatus includes a control unit 350. The control unit 350 has the same construction as the above-described control unit 200. Thus, the control unit 350 includes the controller 29 and the inverter device 26. The first physical quantity sensor 300A is electrically connected to the controller 29 via an electrical wire 301, and the second physical quantity sensor 300B is electrically connected to the controller 29 via an electrical wire 302.

Since the controller 29 has the same construction as the above-described construction, a detailed description thereof is omitted. In this embodiment, the controller 29 calculates, from the physical quantity detected by each of the first physical quantity sensor 300A and the second physical quantity sensor 300B, the rate of change in the physical quantity corresponding to each of the first physical quantity sensor 300A and the second physical quantity sensor 300B and, when at least one of the calculated values is higher than a predetermined threshold value, performs at least one of an operation to stop the supply of electric current to the motor 260 and an operation to issue an alarm.

Though not shown diagrammatically, in the embodiment shown in FIG. 14, the inverter device 26 has the same construction as the above-described construction; therefore, a detailed description of the inverter device 26 is omitted.

The pump apparatus according to this embodiment can achieve the same effects as those of the above-described embodiments. The pump apparatus can prevent damage to the bearings even when foreign matter clogs the gaps between the bearings and the rotation-side members. Further, the pump apparatus can prevent damage to the bearings caused by operating the canned motor pump 250 in the absence of a liquid.

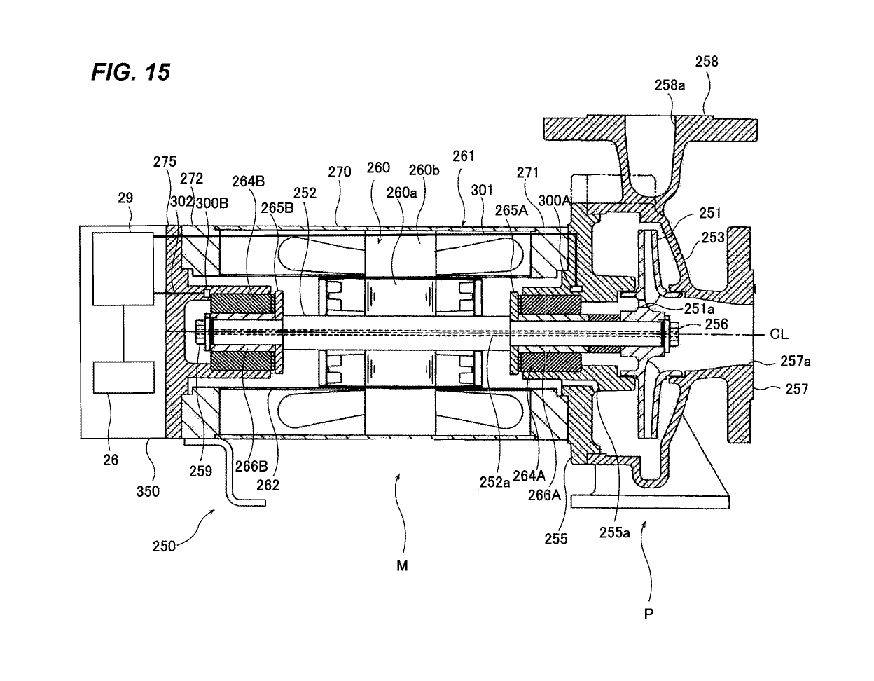

FIG. 15 is a cross-sectional view showing yet another embodiment of a pump apparatus. The pump apparatus of FIG. 15 includes a control unit 350 connected to the motor casing 261. In this embodiment, the pump casing 253, the motor casing 261 and the control unit 350 are disposed linearly in the direction of the axis CL of the rotating shaft 252. The control unit 350 is secured to the end cover 275 and has the same diameter as the motor casing 261.

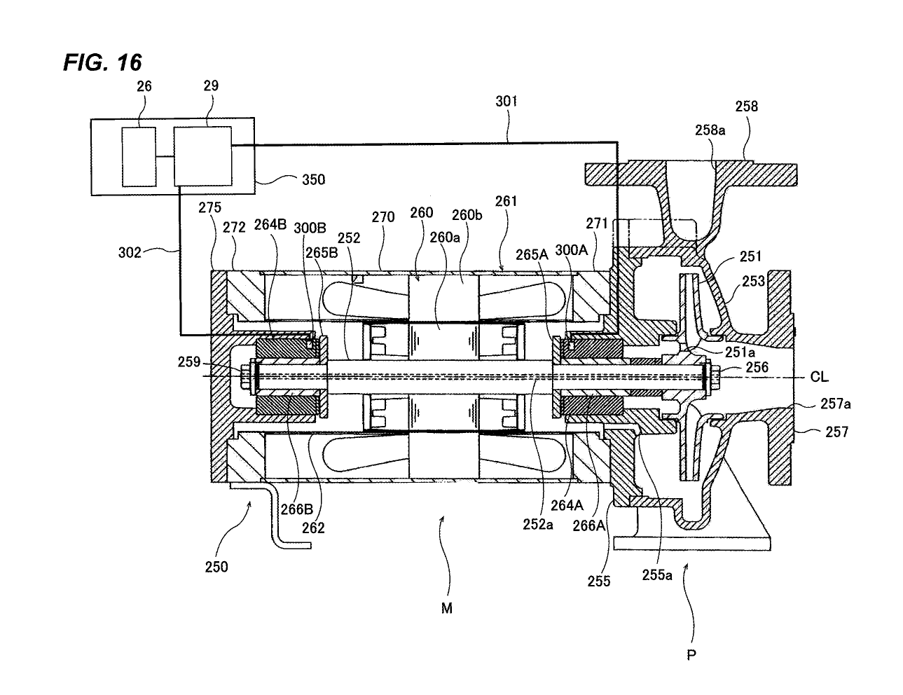

FIG. 16 is a cross-sectional view showing yet another embodiment of a pump apparatus. In the pump apparatus of FIG. 16, the first physical quantity sensor 300A is embedded in the first bearing 264A, and the second physical quantity sensor 300B is embedded in the second bearing 264B. The first physical quantity sensor 300A and the second physical quantity sensor 300B may be disposed at positions different from those of FIG. 16 as long as the physical quantity sensors 300A and 300B are embedded in the bearings 264A and 264B, respectively.

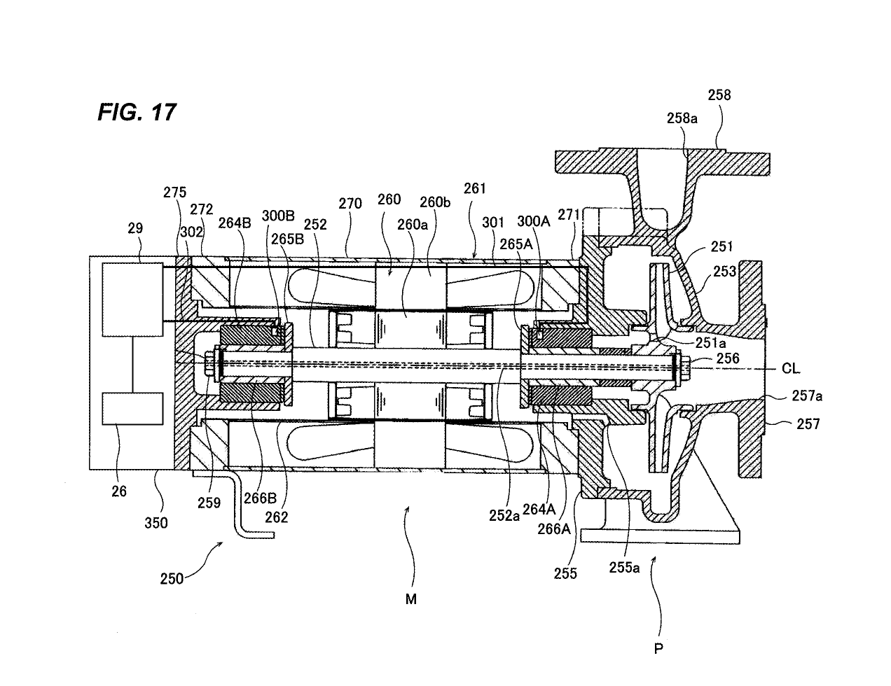

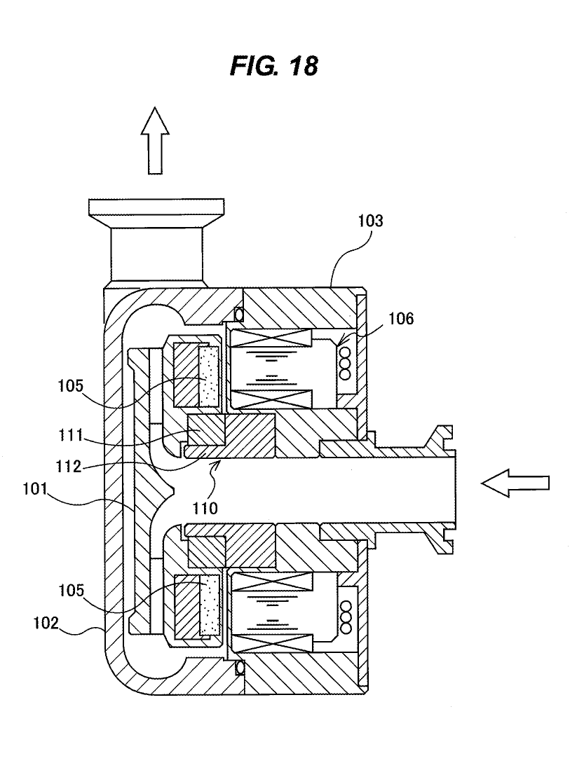

FIG. 17 is a cross-sectional view showing yet another embodiment of a pump apparatus. The pump apparatus according to the embodiment shown in FIG. 17 includes the same control unit 350 as that of the embodiment shown in FIG. 15. Also in this embodiment, the pump casing 253, the motor casing 261 and the control unit 350 are disposed linearly in the direction of the axis CL of the rotating shaft 252.

While the present invention has been described with reference to the embodiments thereof, it will be understood that the present invention is not limited to the particular embodiments described above, but it is intended to cover changes and modifications within the inventive concept.

### INDUSTRIAL APPLICABILITY

The present invention is applicable to a pump apparatus.

### REFERENCE SIGNS LIST

1 impeller
2 pump casing
3 motor casing
4 end cover
5 permanent magnet
6 motor stator
10 bearing assembly
11 rotation-side bearing
12 stationary-side bearing
13 cylindrical portion
14 flange portion
25 leads
26 inverter device
28 power source
29 controller
30 vibration sensor
31, 61 sensor cable
32, 62 signal line
35, 45 storage device
36, 46 comparator
40 converter section
41 inverter section
42 drive control section
44 emergency signal transmitter
45, 75 storage device
46, 76 comparator
47 sensor signal processor
48 current detector
50 motor pump
60 sound sensor
70 temperature sensor
71 sensor cable
72 signal line
200 control unit
250 canned motor pump
251 impeller
252 rotating shaft
252a axial through-hole
253 pump casing
255 casing cover
255a fluid communication hole
256 fastening tool
257 suction port
257a suction opening
258 discharge port
258a discharge opening
259 fastening tool
260 motor
260a motor rotor
260b motor stator
261 motor casing
262 can
264A first bearing
264B second bearing
265A, 265B thrust plate
266A, 266B shaft sleeve
270 motor frame
271, 272 frame side plate
275 end cover
300A first physical quantity sensor
300B second physical quantity sensor
301, 302 electrical wire
350 control unit

1. A pump apparatus comprising:
an impeller in which a permanent magnet is embedded;
a pump casing which houses the impeller;
a motor stator having a plurality of stator coils;
a motor casing which houses the motor stator;
a bearing assembly which supports the impeller;
a vibration sensor for detecting a vibration of the bearing assembly; and
a controller connected to the vibration sensor, wherein the controller calculates the rate of change in the vibration based on the vibration detected by the vibration sensor and, when the rate of change in the vibration is higher than a predetermined threshold value, performs at least one of an operation to stop the supply of electric current to the motor stator and an operation to trigger an alarm.

2. The pump apparatus according to claim 1, further comprising an inverter device which supplies electric current to the motor stator, wherein the threshold value is a first threshold value, and wherein the controller is connected to the inverter device, calculates the rate of change in the electric current supplied from the inverter device to the motor stator and, when the rate of change in the vibration is higher than the first threshold value, and the rate of change in the electric current increases and exceeds a second threshold value, performs at least one of an operation to stop the supply of electric current to the motor stator and an operation to trigger an alarm.

3. The pump apparatus according to claim 1, wherein the bearing assembly comprises a stationary-side bearing, and a rotation-side bearing disposed around the stationary-side bearing, the rotation-side bearing secured to the impeller and the stationary-side bearing secured to the motor casing, and wherein the vibration sensor is embedded in the motor casing.

4. The pump apparatus according to claim 1, wherein the bearing assembly comprises a stationary-side bearing, and a rotation-side bearing disposed around the stationary-side bearing, the rotation-side bearing secured to the impeller and the stationary-side bearing secured to the motor casing, and wherein the vibration sensor is embedded in the stationary-side bearing.

5. A pump apparatus comprising:
an impeller in which a permanent magnet is embedded;
a pump casing which houses the impeller;
a motor stator having a plurality of stator coils;
a motor casing which houses the motor stator;
a bearing assembly which supports the impeller;
a sound sensor for detecting a sound generated by the bearing assembly; and
a controller connected to the sound sensor, wherein the controller calculates the rate of change in the sound based on the sound detected by the sound sensor and, when the rate of change in the sound is higher than a predetermined threshold value, performs at least one of an operation to stop the supply of electric current to the motor stator and an operation to trigger an alarm.

6. The pump apparatus according to claim 5, further comprising an inverter device which supplies electric current to the motor stator, wherein the threshold value is a first threshold value, and wherein the controller is connected to the inverter device, calculates the rate of change in the electric current supplied from the inverter device to the motor stator and, when the rate of change in the sound is higher than the first threshold value, and the rate of change in the electric current increases and exceeds a second threshold value, performs at least one of an operation to stop the supply of electric current to the motor stator and an operation to trigger an alarm.

7. A pump apparatus comprising:
an impeller in which a permanent magnet is embedded;
a pump casing which houses the impeller;
a motor stator having a plurality of stator coils;
a motor casing which houses the motor stator;
a bearing assembly which supports the impeller;
a temperature sensor for detecting a temperature of the bearing assembly; and
a controller connected to the temperature sensor, wherein the controller calculates the rate of change in the temperature based on the temperature detected by the temperature sensor and, when the rate of change in the temperature is higher than a predetermined threshold value, performs at least one of an operation to stop the supply of electric current to the motor stator and an operation to trigger an alarm.

8. The pump apparatus according to claim 7, further comprising an inverter device which supplies electric current to the motor stator, wherein the threshold value is a first threshold value, and wherein the controller is connected to the inverter device, calculates the rate of change in the electric current supplied from the inverter device to the motor stator and, when the rate of change in the temperature is higher than the first threshold value, and the rate of change in the electric current increases and exceeds a second threshold value, performs at least one of an operation to stop the supply of electric current to the motor stator and an operation to trigger an alarm.

9. The pump apparatus according to claim 7, wherein the bearing assembly comprises a stationary-side bearing, and a rotation-side bearing disposed around the stationary-side bearing, the rotation-side bearing secured to the impeller and the stationary-side bearing secured to the motor casing, and wherein the temperature sensor is embedded in the motor casing.

10. The pump apparatus according to claim 7, wherein the bearing assembly comprises a stationary-side bearing, and a rotation-side bearing disposed around the stationary-side bearing, the rotation-side bearing secured to the impeller and the stationary-side bearing secured to the motor casing, and wherein the temperature sensor is embedded in the stationary-side bearing.

11. A pump apparatus comprising:
an impeller;
a rotating shaft to which the impeller is secured;
a pump casing which houses the impeller;
a motor for rotating the rotating shaft;
a motor casing which houses the motor;
a bearing which supports the rotating shaft;
a physical quantity sensor for detecting a physical quantity of the bearing; and
a controller connected to the physical quantity sensor, wherein the controller calculates the rate of change in the physical quantity based on the physical quantity detected by the physical quantity sensor and, when the rate of change in the physical quantity is higher than a predetermined threshold value, performs at least one of an operation to stop the supply of electric current to the motor and an operation to trigger an alarm.

12. The pump apparatus according to claim 11, further comprising a casing cover secured to a high pressure-side opening of the pump casing, wherein the motor casing includes an end cover disposed on the opposite side of the motor from the casing cover, wherein the bearing is comprised of a first bearing mounted to the casing cover, and a second bearing mounted to the end cover, and wherein the physical quantity sensor is comprised of a first physical quantity sensor embedded in the casing cover, and a second physical quantity sensor embedded in the end cover.

13. The pump apparatus according to claim 11, further comprising a casing cover secured to a high pressure-side opening of the pump casing, wherein the motor casing includes an end cover disposed on the opposite side of the motor from the casing cover, wherein the bearing is comprised of a first bearing mounted to the casing cover, and a second bearing mounted to the end cover, and wherein the physical quantity sensor is comprised of a first physical quantity sensor embedded in the first bearing, and a second physical quantity sensor embedded in the second bearing.

14. The pump apparatus according to claim 11, further comprising a control unit including the controller and an inverter device which supplies electric current to the motor, wherein the pump casing, the motor casing and the control unit are disposed linearly in the axial direction of the rotating shaft.

15. The pump apparatus according to claim 11, wherein the physical quantity sensor is selected from a vibration sensor for detecting a vibration of the bearing, a sound sensor for detecting a sound generated by the bearing, and a temperature sensor for detecting a temperature of the bearing.
